(19) United States
(12) Patent Application Publication
(10) Pub. No.: US 2002/0090055 A1
(43) Pub. Date: Jul. 11, 2002

(54) Digital X-ray bucky including grid storage

(75) Inventors: Albert Zur, Ganei Tikva (IL); Benjamin Sas, Rehovot (IL); Baruch Bachar, Givatayim (IL)

Correspondence Address: LADAS & PARRY, 26 WEST 61ST STREET, NEW YORK, NY, 10023, US

(73) Assignee: EDGE MEDICAL DEVICES LTD.

(21) Appl. No.: 09/994,469

(22) Filed: Nov. 26, 2001

Related U.S. Application Data
(60) Provisional application No. 60/253,363, filed on Nov. 27, 2000.

(51) Int. Cl. G21K 1/00

(52) U.S. Cl. 378/154; 378/155

(57) ABSTRACT

A bucky device and method including an X-ray image detector, an anti-scatter grid, a first chamber disposed to house the grid in an active position in which the grid is positioned upstream of the X-ray image detector in respect to x-ray impingement and a second chamber disposed to house the grid in a storage position in which the grid is positioned downstream of the X-ray image detector in respect to x-ray impingement.

### FIELD OF THE INVENTION

The present invention relates to systems and methods in the field of X-ray imaging.

### BACKGROUND OF THE INVENTION

There are described in the patent literature numerous systems and methods for the recording of X-ray images. Conventional X-ray imaging systems use an X-ray sensitive phosphor screen and a photosensitive film placed in a cartridge to form visible analog representations of modulated X-ray patterns. The phosphor screen absorbs X-ray radiation and emits visible light. The visible light exposes the photosensitive film to form a latent image of the X-ray pattern. The film is then chemically processed to transform the latent image into a visible analog representation of the X-ray pattern.

During X-ray imaging, it is common practice to use an anti-scatter grid when the object to be imaged is relatively thick, i.e. a human chest. The use of an anti-scatter grid prevents scattered radiation from affecting the final X-ray image. When the object to be imaged is relatively thin, i.e. extremities, no such grid is typically required for X-ray imaging.

The anti-scatter grid is typically housed in a device known as a bucky. The bucky is usually mounted on an X-ray table or alternatively may be mounted on a radiographic stand. Different approaches to implementation of an anti-scatter grid in an x-ray system and in buckys are known in the art.

U.S. Pat. No. 5,008,920 to Gralak describes an X-ray film cassette with a flexible grid bonded to a prestressed cover. In the embodiment disclosed by Gralak, a flexible X-ray grid is permanently bonded to the interior of a cassette cover.

U.S. Pat. No. 4,951,305 to Moore et al describes an X-ray grid for medical radiography.

Other conventional X-ray systems and methods are described in the following United States Patents: U.S. Pat. No. 5,276,333 to Robertson; U.S. Pat. No. 6,244,507 B1 to Garland et al; U.S. Pat. No. 5,666,395 to Tsukamoto et al; U.S. Pat. No. 4,457,010 to Jenkins et al.

For analog X-ray imaging procedures where the anti-scatter grid is not required, the bucky is typically not used and the film cartridge is disposed directly under the patient.

Recently, there have been proposed systems and methods for digital detection of static and dynamic X-ray images. These digital X-ray systems and methods provide digital representations of X-ray images in which the X-ray image is recorded as readable electrical signals, thus obviating the need for films and screen in the imaging process. Digital X-ray systems typically rely on direct conversion of X-rays to charge carriers or alternatively indirect conversion in which X-rays are converted to light which is then converted to charge carriers and charge readout.

When using digital X-ray detectors, special considerations and methods regarding the implemenation of an anti-scatter grid and bucky are required due to the fact that digital detectors are typically not easily transferable due to relative bulk, handling considerations and the fact that cables for power and data transfer extend therefrom.

The disclosures of all publications mentioned in the specification and of the publications cited therein are hereby incorporated by reference.

### SUMMARY OF THE INVENTION

The present invention seeks to provide improved X-ray imaging apparatus and methods.

There is thus provided in accordance with a preferred embodiment of the present invention a bucky device including an X-ray image detector, an anti-scatter grid, a first chamber disposed to house the grid in an active position in which the grid is positioned upstream of the X-ray image detector in respect to x-ray impingement and a second chamber disposed to house the grid in a storage position in which the grid is positioned downstream of the X-ray image detector in respect to x-ray impingement.

Further in accordance with a preferred embodiment of the present invention the system also includes a source of X-ray radiation.

Still further in accordance with a preferred embodiment of the present invention the X-ray image detector is a digital X-ray image detector.

Additionally in accordance with a preferred embodiment of the present invention the bucky device also includes an automatic exposure control device.

Further in accordance with a preferred embodiment of the present invention the anti-scatter grid is mounted onto an extractable frame.

Preferably, the anti-scatter grid is removably mounted onto the extractable frame.

Further in accordance with a preferred embodiment of the present invention the extractable frame includes at least one handle.

Additionally in accordance with a preferred embodiment of the present invention the system also includes a motorized means to facilitate grid extraction, insertion and positioning.

Still further in accordance with a preferred embodiment of the present invention the system also includes visible lights indicating the status of the anti-scatter grid.

There is also provided in accordance with a preferred embodiment of the present invention an X-ray method, which includes providing a digital bucky including an image detection module and an anti-scatter grid, wherein the anti-scatter grid has an active position upstream of the image detection module with respect to X-ray impingement and a storage position downstream of the image detection module with respect to X-ray impingement, performing at least one X-ray imaging procedure which employs the anti-scatter grid and at least one X-ray imaging procedure which does not employ the anti-scatter grid and between the procedures, disposing the anti-scatter grid from a first position from among its the active and storage positions, to a second position from among its the active and storage positions.

Further in accordance with a preferred embodiment of the present invention the step of disposing the anti-scatter-grid is partially or fully motorized.

### BRIEF DESCRIPTION OF THE DRAWINGS

The present invention will be understood and appreciated from the following detailed description, taken in conjunction with the drawings in which:

FIGS. 1A and 1B respectively illustrate X-ray imaging systems constructed and operative in accordance with two respective preferred embodiments of the present invention; and

FIGS. 2A-2D are isometric drawings of four respective operative positions of a digital bucky device which preferably forms part of the X-ray imaging systems of FIGS. 1A and 1B, including an active position in FIG. 2A in which the anti-scatter grid is disposed interiorly of an active chamber of the digital bucky device, a storage position in FIG. 2D in which the anti-scatter grid is disposed interiorly of a storage chamber of the digital bucky device, and two intermediate positions in FIGS. 2B and 2C.

### DETAILED DESCRIPTION OF PREFERRED EMBODIMENTS

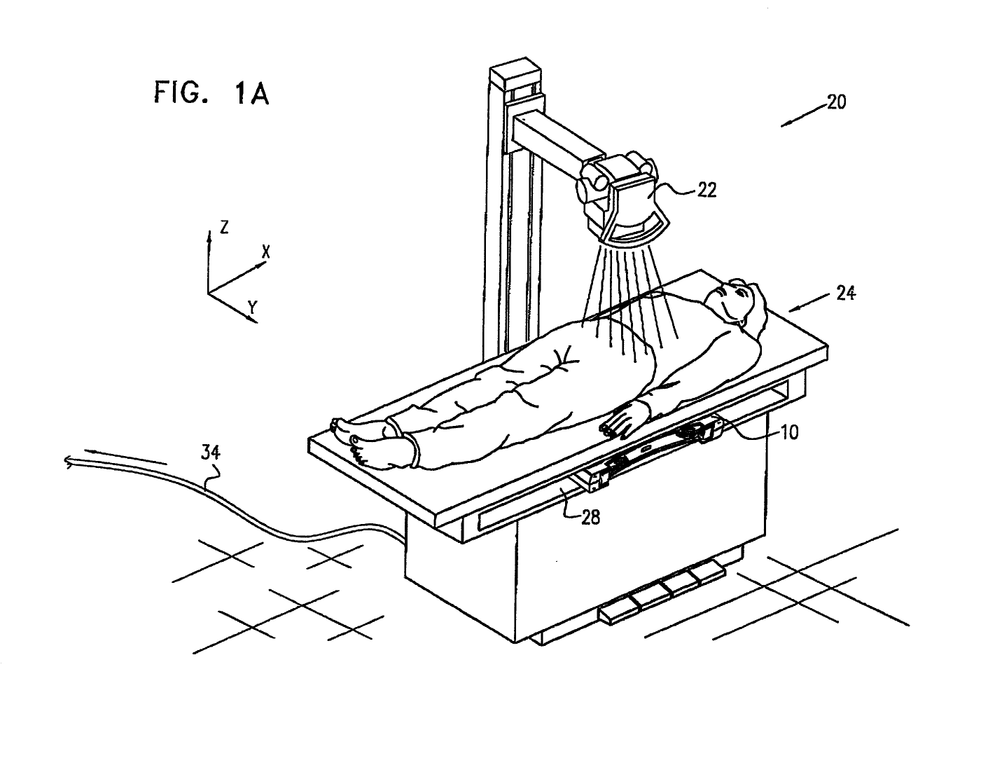

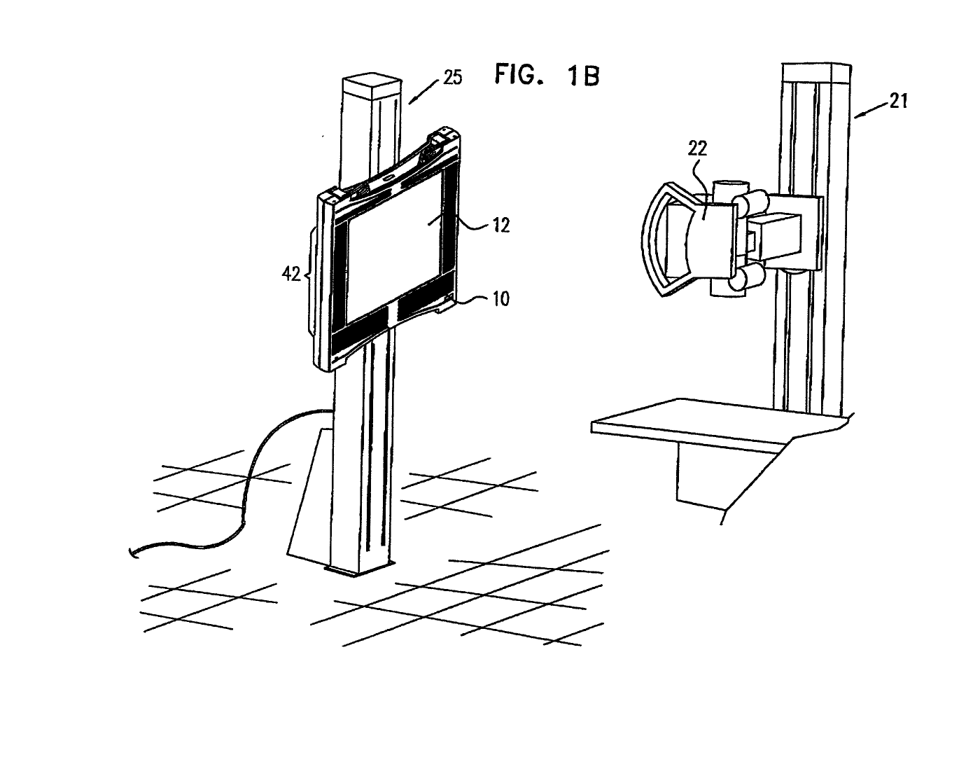

Reference is now made to FIGS. 1A and 1B which illustrate X-ray systems for digital X-ray detection incorporating a digital X-ray bucky device 10 housing an anti-scatter grid 12, shown in FIG. 1B, in accordance with a preferred embodiment of the present invention which is particularly suited for general radiographic applications.

FIGS. 1A and 1B each typically include digital X-ray bucky devices 10, constructed and operative in accordance with a preferred embodiment of the present invention, incorporated into standard X-ray systems 20 and 21, respectively, which may be of the type sold by Philips Medical Systems, the Fischer Imaging Corporation, the Bennett subsidiary of Trex Medical Corporation, etc. In addition to digital X-ray bucky device 10, X-ray systems 20 and 21 typically include a source of X-ray radiation 22, an X-ray table 24 (FIG. 1A) and/or a vertical radiographic stand 25 (FIG. 1B), It is appreciated that the source of X-ray radiation 22 can be swiveled for use with vertical chest stand 25 as shown in FIG. 1B. Alternatively, a ceiling mounted X-ray source may be used (not shown).

Digital X-ray bucky device 10, which is preferably installed in the bucky/grid opening 28 of X-ray table 24 in place of the standard analog film bucky. Alternatively, for a radiographic stand implementation, digital X-ray bucky device 10 may be mounted directly on the vertical chest stand 24 in place of a standard analog bucky.

It is appreciated that, in accordance with this preferred embodiment of the present invention, the digital bucky device 10 may be installed in place of an existing analog (film) bucky device in other suitable X-ray devices, e.g. a U-arm system.

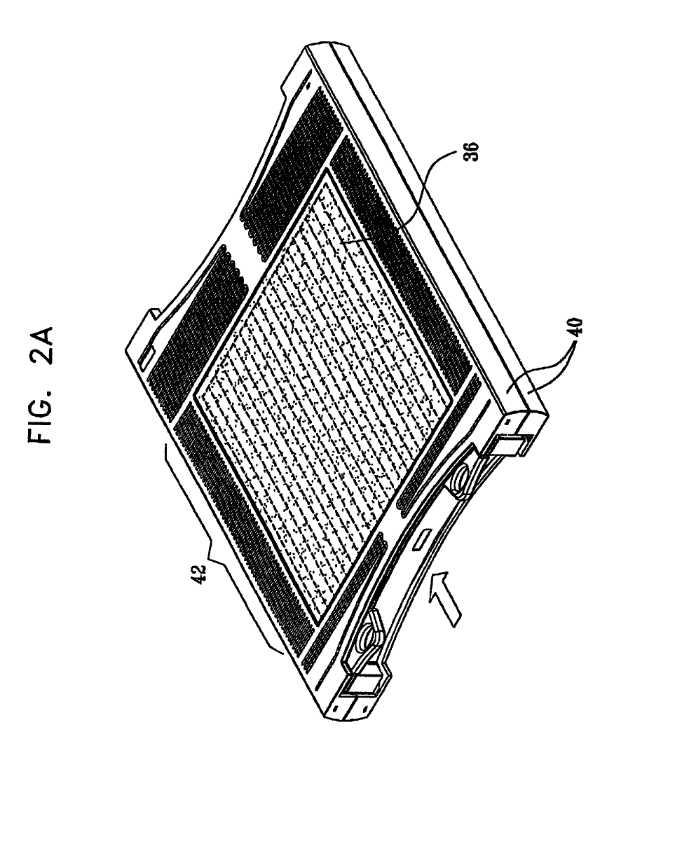

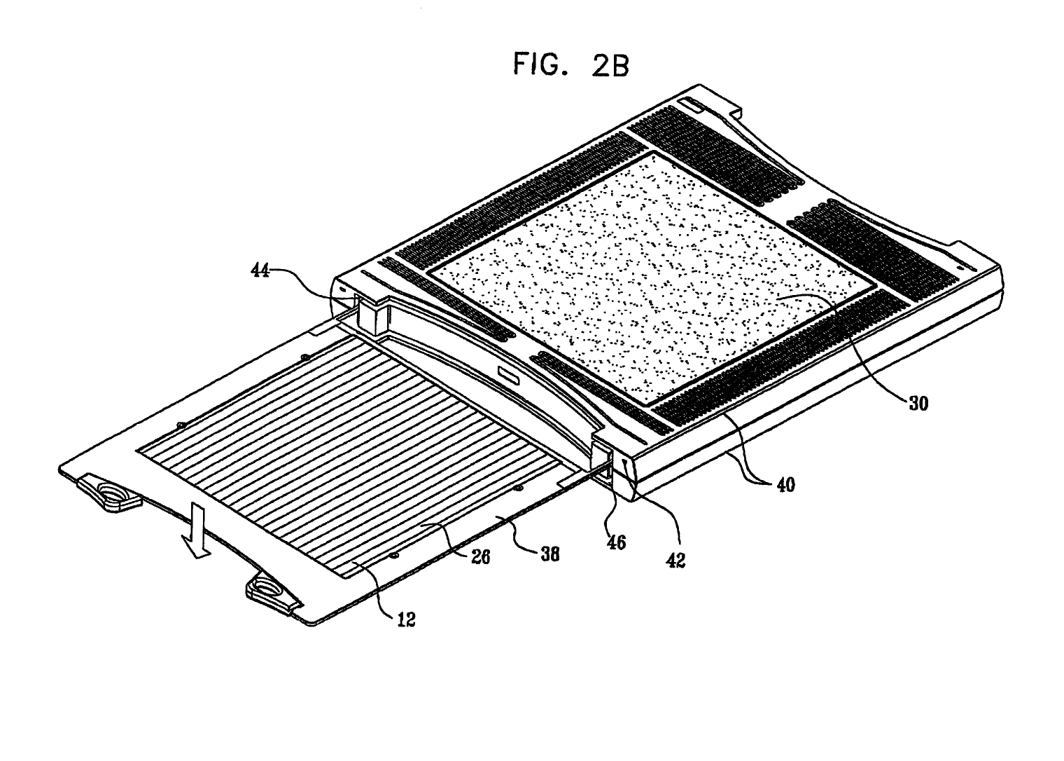

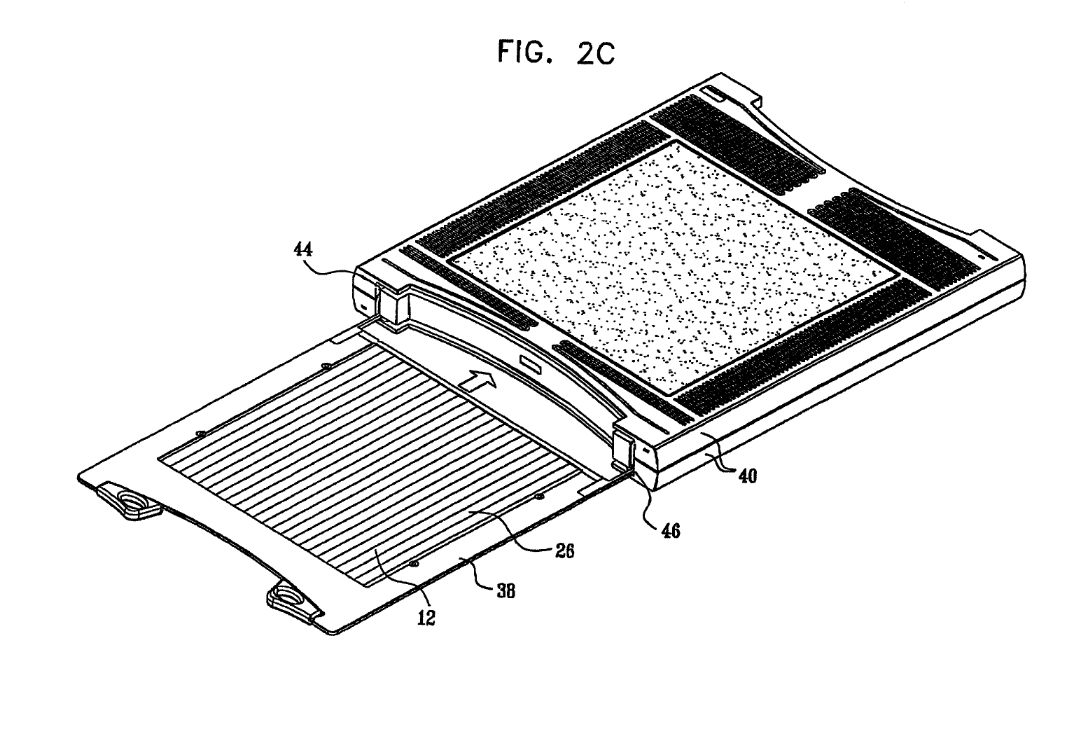

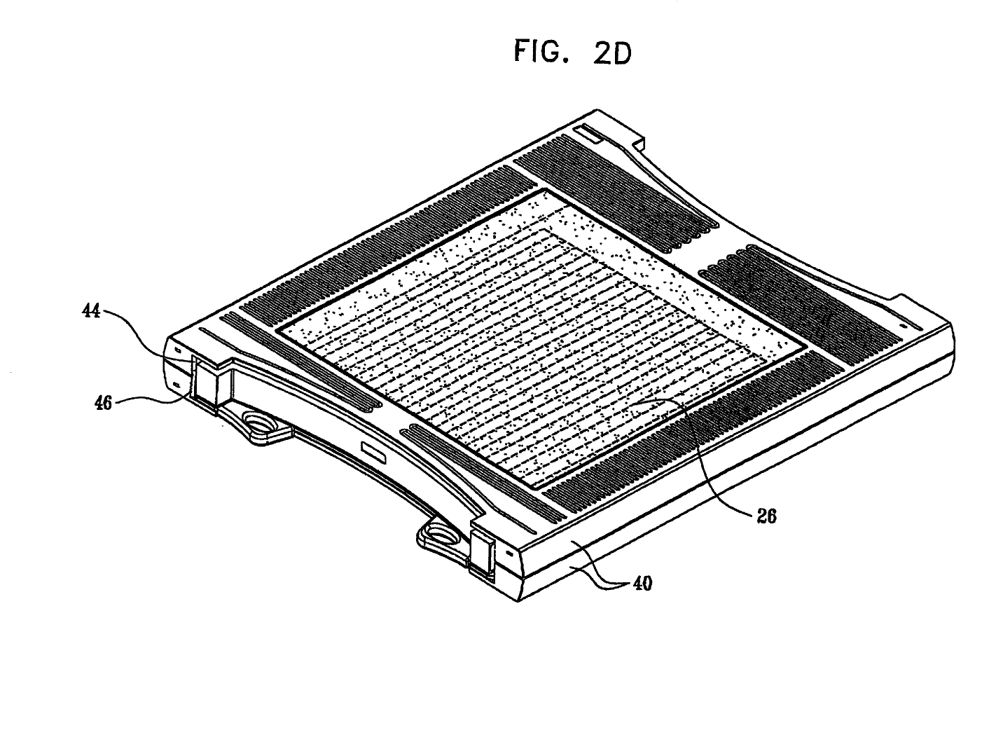

Digital X-ray bucky device 10 preferably includes an image detection module 30 (FIG. 2B) which is preferably a flat panel X-ray detector for digital radiography such as that described in Edge's U.S. patent application Ser. No. 09/233,327 or 09/233,320 or 09/292,316 or such as the X-ray detectors marketed by Trixell SAS of Moirans, France, Canon Medical Systems of Lake Success, N.Y. or Hologic Corporations, Direct Radiography Corporation of Bedford, Mass. For illustrative clarity, the image detection module 30 is shown to be semi-transparent such that the grid 12 is semi-visible when disposed below the module 30 as shown in FIG. 2D, however it is appreciated that this need not be the case.

Anti-scatter grid 12 is typically a static (non-reciprocating) grid which may comprise an aluminum interspaced X-ray grid such as those available from Jungwon Precision Industries, Seoul, Korea. In order to ensure that the lamella of the anti-scatter grid do not appear on the final digital X-ray image in imaging procedures in which the anti-scatter grid 12 is positioned upstream of the image detection module 30, anti-scatter grid 12 is preferably characterized by a line pair density which is beyond the Nyquist frequency of image detection module 30.

In accordance with an alternative embodiment of the present invention, a reciprocating grid device (not shown) may be used in digital bucky device 10.

In accordance with one embodiment of the present invention, digital bucky device 10 further includes an external automatic exposure control device (not shown) such as an ion chamber or solid state device as known in the art. Alternatively, an automatic exposure control device (not shown) may be integrated within image detection module 26 as described in applicant's PCT application PCT/IL99/00409.

Anti-scatter grid 36 is preferably removably mounted onto an extractable frame 38 which typically has at least one handle 40. It is appreciated that the removable mounting allows the anti-scatter grid 12 to be exchanged in order to enable grids with a variety of focal lengths and/or grid ratios to be used as known in the art. In accordance with a preferred embodiment of the present invention, digital bucky device 10 also includes external indicator lights 42. Preferably, indicator lights 42, which are typically LEDS electronically connected to internal bucky sensors (not shown), provide feedback regarding the position of the anti-scatter grid at any time.

Typically, for service and maintenance, image detection module 26 is easily removable from digital bucky device 10, without requiring the digital bucky device 10 to be removed from the X-ray table 24 or wall stand 25.

During an imaging procedure, a patient to be imaged reclines on X-ray table 24 (FIG. 1A) or, alternatively, stands in front of vertical radiographic stand 25 (FIG. 1B), positioned so that an area of the patient to be imaged lies intermediate the source of X-ray radiation 22 and the image detection module 26. When the source of X-ray radiation 22 is activated, X-ray image detection module 30 “reads” the resulting X-ray image as described herein and outputs a digital signal representation thereof The electrical signal representation may be transferred to a workstation (not shown) via a communications cable 34 for display, diagnostics, processing and archiving.

Reference is now made to FIGS. 2A-2D which illustrate operating positions of the anti-scatter grid 12 of digital X-ray bucky device 10 in accordance with a preferred embodiment of the present invention.

It is appreciated that, typically, the extraction and insertion of the anti-scatter grid 12 of digital X-ray bucky device 10 occurs between subsequent imaging procedures and not during X-ray imaging.

Digital bucky device 10 preferably includes a mechanical housing 40 which provides mechanical interface to an X-ray table 24 (FIG. 1A) or alternatively to an X-ray radiographic stand 25 (FIG. 1B).

Mechanical housing 40 preferably includes a preferably rectangular opening 42 which defines an imaging area. The precise dimensions of opening 42 are defined in accordance with the imaging area of the image detection module 30 (FIG. 2B). Typically, for general radiography, the imaging area is of suitable size e.g. approximately 17″×17″ in order to allow a wide variety of examinations to be performed.

For certain applications, such as in use with a radiographic stand 25 where a patient to be imaged is positioned directly facing or in touching contact with the digital bucky 10, it is preferable to cover imaging opening 42 with a panel (not shown), formed of a material such as carbon fiber that is generally highly translucent to X-ray radiation.

Digital bucky device 10 preferably defines two separate housing chambers 44 and 46 for anti-scatter grid 12. The first housing chamber, the active chamber 44, allows the anti-scatter grid 12 to be positioned upstream of the image detection module 30 in terms of X-ray impingement. Thus, the active chamber 44 is typically located over the image detection module 30 with respect to the top of the digital bucky device 10. It is appreciated that when digital bucky device 10 is vertically mounted as shown in FIG. 1B, the active chamber 44 is the front chamber.

FIG. 2A illustrates the anti-scatter grid 36 in the active chamber 44 with respect to image detection module 26.

Anti-scatter grid 12 is typically placed in the active chamber 44 for imaging procedures which typically require use of an anti-scatter grid. Examples of this type of procedure are chest imaging, pelvic imaging and other relatively thick body regions.

The second housing chamber, the storage chamber 46, allows the anti-scatter grid to be downstream of the image detection module 30 and to therefore not affect the imaging procedure. Thus, the storage chamber 46 is typically located beneath the image detection module 30. It is appreciated that when digital bucky device 10 is vertically mounted as shown in FIG. 1B, the storage chamber 46 is the rear chamber.

Anti-scatter grid 12 is typically placed in the storage chamber 46 for imaging procedures which do not use an anti-scatter grid. Examples of this type of procedure are imaging of extremities, i.e. hands, feet and other relatively thin body regions.

FIG. 2B illustrates an anti-scatter grid 36 that is in the top extraction position of the digital bucky device 10. It is appreciated that the steps of extraction, insertion, and repositioning of anti-scatter grid 36 within digital bucky device 10 may be manual or alternatively, fully or partially motorized using suitable electrically motorized means (not shown), housed within the digital bucky device 10. It is appreciated that the above steps may include a combination of motorized and manual operation where the motorization facilitates manual operation to provide additional ease-of-use. When anti-scatter grid is not positioned either in the active position shown in FIG. 2A or the storage position, shown in FIG. 2D, it is appreciated that preferably no X-ray imaging with image detection module 26 is desirable.

FIG. 2C illustrates an anti-scatter grid that has been translated to a bottom extraction position of digital bucky device 10 and is about to be inserted into the storage position of digital bucky device 10.

FIG. 2D illustrates the storage position of anti-scatter grid 36 with respect to image detection module 26. In this position, anti-scatter grid is not used during X-ray imaging and is instead safely stored beneath the image detection module 256, i.e. downstream of the image detection module with respect to the X-ray radiation in the storage chamber 46.

For imaging exposures e.g. extremities imaging, which do not require a grid between an object to be imaged (not shown) and digital detector 5, the grid 7 is preferably extracted from the active position (FIG. 1) and inserted into a storage position, beneath the digital detector 5 and safely stored therein. The storage position is shown in FIG. 2D.

It is appreciated that any software components associated with the electrical motorized driving means (not shown) of the present invention may be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A bucky device comprising:
an X-ray image detector;
an anti-scatter grid;
a first chamber disposed to house the grid in an active position in which the grid is positioned upstream of the X-ray image detector in respect to x-ray impingement; and
a second chamber disposed to house the grid in a storage position in which the grid is positioned downstream of the X-ray image detector in respect to x-ray impingement.

2. A system according to claim 1 and also comprising a source of X-ray radiation.

3. A system according to claim 1 and wherein the X-ray image detector is a digital X-ray image detector.

4. A system according to claim 1 and wherein the bucky device also comprises an automatic exposure control device.

5. A system according to claim 1 wherein the anti-scatter grid is mounted onto an extractable frame.

6. A system according to claim 5 wherein the anti-scatter grid is removably mounted onto the extractable frame.

7. A system according to claim 5 wherein the extractable frame comprises at least one handle.

8. A system according to claim 1 and also comprising motorized means to facilitate grid extraction, insertion and positioning.

9. A system according to claim 1 and also comprising visible lights indicating the status of the anti-scatter grid.

10. An X-ray method comprising:
providing a digital bucky including an image detection module and an anti-scatter grid, wherein the anti-scatter grid has an active position upstream of the image detection module with respect to X-ray impingement and a storage position downstream of the image detection module with respect to X-ray impingement;
performing at least one X-ray imaging procedure which employs the anti-scatter grid and at least one X-ray imaging procedure which does not employ the anti-scatter grid; and
between the procedures, disposing the anti-scatter grid from a first position from among its the active and storage positions, to a second position from among its the active and storage positions.

11. An X-ray method according to claim 9 and wherein the step of disposing the anti-scatter-grid is partially or fully motorized.
